(19) United States
(12) Patent Application Publication
(10) Pub. No.: US 2018/0352240 A1
(43) Pub. Date: Dec. 6, 2018

(54) Generalized Temporal Sub-Layering Frame Work

(71) Applicant: Apple Inc., Cupertino, CA (US)

(72) Inventors: Krishnakanth Rapaka, San Jose, CA (US); Mukta Gore, Santa Clara, CA (US); Sunder Venkateswaran, Sunnyvale, CA (US); Xiaohua Yang, San Jose, CA (US); Xiang Fu, Mountain View, CA (US); Francesco Iacopino, San Jose, CA (US); Linfeng Guo, Cupertino, CA (US)

(21) Appl. No.: 15/613,172

(22) Filed: Jun. 3, 2017

(51) Int. Cl. H04N 19/187; H04N 19/51; H04N 19/31; H04N 19/39

(52) U.S. Cl. CPC H04N 19/187; H04N 19/39; H04N 19/31; H04N 19/51

(57) ABSTRACT

Techniques for encoding video with temporal layering are described, comprising predicting a sequence of pictures with a motion prediction reference pattern having a number of virtual temporal layers, and encoding the sequence of pictures into an encoded bitstream with a temporal layering syntax, wherein a number of signaled temporal layers is less than the number of virtual temporal layers. The number of signaled temporal layers may be determined from a target highest frame rate, a target base layer frame rate, and the number of virtual temporal layers.

### BACKGROUND

This document addresses techniques for video coding with temporal scalability.

Video coding techniques (such as H.264/AVC and H.265/HEVC) provide techniques for temporal scalability, also known as temporal layering. Temporal scalability segments a compressed video bitstream into layers that allow for decoding and playback of the bitstream at a variety of frame rates. In such layering systems, the portion of an encoded bitstream comprising a lower layer can be decoded with a lower output frame rate without the portion of the bitstream comprising upper layers, while decoding an upper layer (for a higher output frame rate) requires decoding all lower layers. The lowest temporal layer is the base layer with the lowest frame rate, while higher temporal layers are enhancement layers with higher frame rates.

Temporal scalability is useful in a variety of settings, such as where there is insufficient bandwidth to transmit an entire encoded bitstream, where only lower layers are transmitted to produce a useful, lower frame rate output at a decoder without needing to transmit upper layers. Temporal scalability also provides a mechanism for reducing decoder complexity by decoding only lower temporal layers, for example when a decoder does not have sufficient resources to decoder all layers or when a display is incapable of presenting the highest frame rate from the highest layer. Temporal scalability also provides trick-mode playback, such as fast-forward playback.

Video coding techniques with motion prediction impose constraints on the references when predicting inter-frame motion. For example, I-frames (or intra-coded frames) do not predict motion from any other frame, P-frames are predicted from a single reference frame, and B-frames are predicted from two reference frames. Video coding techniques for temporal scalablity may impose further constraints. For example, in an HEVC encoded video sequence, temporal sublayer access (TSA) and stepwise TSA (STSA) pictures can be identified. In HEVC, a decoder may switch the number of layers being decoded mid-stream. A TSA picture indicates when a decoder can safely increase the number of layers being decoded to include any higher layers. A STSA picture identifies when a decoder can safely increase the number of layers decoded to an immediately higher layer. Identification of TSA and STSA pictures imposes constraints on which frames may be used as motion prediction references.

Inventors perceive a need for improved techniques for video compression with temporal-scalability, better balancing video encoding goals such as coding efficiency, complexity, and latency in real-time encoding, while also meeting constraints in prediction structure, such as those imposed by H.264 and H.265 video coding standards.

### BRIEF DESCRIPTION OF THE DRAWINGS

FIG. 1(a) is an example simplified block diagram of a video delivery system.

FIG. 1(b) is an example functional block diagram illustrating components of an encoding terminal.

FIG. 1(c) is an example functional block diagram illustrating components of a decoding terminal.

FIG. 2(a) depicts an example sequence of images in presentation order.

FIG. 2(b) depicts an example a sequence of images in coding order.

FIG. 3 depicts an example video sequence with two temporal layers in a dyadic prediction structure.

FIG. 4 depicts an example video sequence with three temporal layers in a dyadic prediction structure.

FIG. 5 depicts a video sequence with four temporal layers in a dyadic prediction structure.

FIG. 6 depicts an example a video sequence with four virtual temporal layers in a dyadic prediction structure and one signaled temporal layer.

FIG. 7 depicts an example a video sequence with four virtual temporal layers in a dyadic prediction structure and two signaled temporal layers.

FIG. 8 depicts an example a video sequence with four virtual temporal layers in a dyadic prediction structure and three signaled temporal layers.

FIG. 9 depicts a flowchart of an example process for encoding a video with virtual temporal layers.

### DETAILED DESCRIPTION

Techniques for video coding with temporal scalability are presented. Embodiments of the techniques include structures of inter-frame motion prediction references that meet prediction constraints of temporal scalability, such as the constraints of temporal scalability modes of H.264 and H.265 video coding standards, while also balancing such video coding goals as coding efficiency, complexity, and latency in real-time encoding. In embodiments, the structure of inter-frame motion prediction references may include a virtual temporal layering structure with more virtual temporal layers than there are identified temporal layers actually encoded into a temporally scalable bitstream. For example, a video may be encoded with a dyadic prediction structure of N virtual layers, where the resultant encoded bitstream only identifies N−1 actual temporal layers. Two or more virtual temporal layers may be combined into a single signaled temporal layer in the encoded bitstream, for example by combining the lowest virtual temporal layers (the layers with the lowest time resolution or lowest frame). Such virtual temporal layers may be useful to improve coding efficiency and balance practical encoding constraints, such as real-time video encoding where the framerate input to an encoder is variable, or where some frames expected at the input to an encoder are missing.

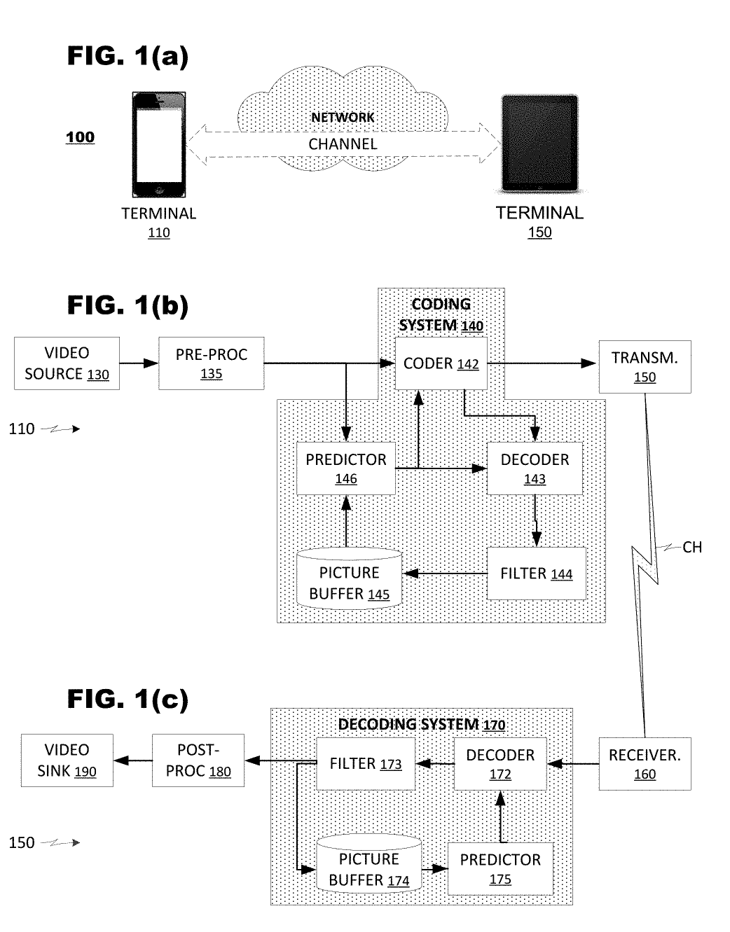

FIG. 1(a) is a simplified block diagram of a video delivery system 100 according to an embodiment of the present disclosure. The system 100 may include a plurality of terminals 110, 150 interconnected via a network. The terminals 110, 150 may code video data for transmission to their counterparts via the network. Thus, a first terminal 110 may capture video data locally, code the video data, and transmit the coded video data to the counterpart terminal 150 via a channel. The receiving terminal 150 may receive the coded video data, decode it, and render it locally, for example, on a display at the terminal 150. If the terminals are engaged in bidirectional exchange of video data, then the terminal 150 may capture video data locally, code the video data, and transmit the coded video data to the counterpart terminal 110 via another channel. The receiving terminal 110 may receive the coded video data transmitted from terminal 150, decode it, and render it locally, for example, on its own display.

A video coding system 100 may be used in a variety of applications. In a first application, the terminals 110, 150 may support real time bidirectional exchange of coded video to establish a video conferencing session between them. In another application, a terminal 110 may code pre-produced video (for example, television or movie programming) and store the coded video for delivery to one or, often, many downloading clients (e.g., terminal 150). Thus, the video being coded may be live or pre-produced, and the terminal 110 may act as a media server, delivering the coded video according to a one-to-one or a one-to-many distribution model. For the purposes of the present discussion, the type of video and the video distribution schemes are immaterial unless otherwise noted.

In FIG. 1(a), the terminals 110, 150 are illustrated as smart phones and tablet computers, respectively, but the principles of the present disclosure are not so limited. Embodiments of the present disclosure also find application with computers (both desktop and laptop computers), computer servers, media players, dedicated video conferencing equipment, and/or dedicated video encoding equipment. Embodiments may be performed by instructions stored in memory and executed on computer processors, and may also be performed by special-purpose hardware.

The network represents any number of networks that convey coded video data between the terminals 110, 150, including, for example, wireline and/or wireless communication networks. The communication network may exchange data in circuit-switched or packet-switched channels. Representative networks include telecommunications networks, local area networks, wide area networks, and/or the Internet. For the purposes of the present discussion, the architecture and topology of the network are immaterial to the operation of the present disclosure unless otherwise noted.

FIG. 1(b) is an example functional block diagram illustrating components of an encoding terminal 110. The encoding terminal may include a video source 130, a pre-processor 135, a coding system 140, and a transmitter 150. The video source 130 may supply video to be coded. The video source 130 may be provided as a camera that captures image data of a local environment or a storage device that stores video from some other source. The pre-processor 135 may perform signal conditioning operations on the video to be coded to prepare the video data for coding. For example, the preprocessor 135 may alter frame rate, frame resolution, and other properties of the source video. The preprocessor 135 also may perform filtering operations on the source video.

The coding system 140 may perform coding operations on the video to reduce its bandwidth. Typically, the coding system 140 exploits temporal and/or spatial redundancies within the source video. For example, the coding system 140 may perform motion compensated predictive coding in which video frame or field pictures are parsed into sub-units (called “pixel blocks,” for convenience), and individual pixel blocks are coded differentially with respect to predicted pixel blocks, which are derived from previously-coded video data. A given pixel block may be coded according to any one of a variety of predictive coding modes, such as:
Intra-coding, in which an input pixel block is coded differentially with respect to previously coded/decoded data of a common frame.
Single prediction inter-coding, in which an input pixel block is coded differentially with respect to data of a previously coded/decoded frame.
Bi-predictive inter-coding, in which an input pixel block is coded differentially with respect to data of a pair of previously coded/decoded frames.
Combined inter-intra coding, in which an input pixel block is coded differentially with respect to data from both a previously coded/decoded frame and data from the current/common frame.
Multi-hypothesis inter-intra coding, in which an input pixel block is coded differentially with respect to data from several previously coded/decoded frames, as well as potentially data from the current/common frame.

Pixel blocks also may be coded according to other coding modes. Any of these coding modes may induce visual artifacts in decoded images, and artifacts at block boundaries may be particularly noticeable to the human visual system.

The coding system 140 may include a coder 142, a decoder 143, an in-loop filter 144, a picture buffer 145, and a predictor 146. The coder 142 may apply the differential coding techniques to the input pixel block using predicted pixel block data supplied by the predictor 146. The decoder 143 may invert the differential coding techniques applied by the coder 142 to a subset of coded frames designated as reference frames. The in-loop filter 144 may apply filtering techniques, including deblocking filtering, to the reconstructed reference frames generated by the decoder 143. The picture buffer 145 may store the reconstructed reference frames for use in prediction operations. The predictor 146 may predict data for input pixel blocks from within the reference frames stored in the picture buffer.

The transmitter 150 may transmit coded video data to a decoding terminal via a channel CH.

FIG. 1(c) is an example functional block diagram illustrating components of a decoding terminal 150 according to an embodiment of the present disclosure. The decoding terminal may include a receiver 160 to receive coded video data from the channel, a video decoding system 170 that decodes coded data, a post-processor 180, and a video sink 190 that consumes the video data.

The receiver 160 may receive a data stream from the network and may route components of the data stream to appropriate units within the terminal 200. Although FIGS. 1(b) and 1(c) illustrate functional units for video coding and decoding, terminals 110, 120 typically will include coding/decoding systems for audio data associated with the video and perhaps other processing units (not shown). Thus, the receiver 160 may parse the coded video data from other elements of the data stream and route it to the video decoder 170.

The video decoder 170 may perform decoding operations that invert coding operations performed by the coding system 140. The video decoder may include a decoder 172, an in-loop filter 173, a picture buffer 174, and a predictor 175. The decoder 172 may invert the differential coding techniques applied by the coder 142 to the coded frames. The in-loop filter 144 may apply filtering techniques, including deblocking filtering, to reconstructed frame data generated by the decoder 172. For example, the in-loop filter 144 may perform various filtering operations (e.g., de-blocking, de-ringing filtering, sample adaptive offset processing, and the like). The filtered frame data may be output from the decoding system. The picture buffer 174 may store reconstructed reference frames for use in prediction operations. The predictor 175 may predict data for input pixel blocks from within the reference frames stored by the picture buffer according to prediction reference data provided in the coded video data.

The post-processor 180 may perform operations to condition the reconstructed video data for display. For example, the post-processor 180 may perform various filtering operations (e.g., de-blocking, de-ringing filtering, and the like), which may obscure visual artifacts in output video that are generated by the coding/decoding process. The post-processor 180 also may alter resolution, frame rate, color space, etc. of the reconstructed video to conform it to requirements of the video sink 190.

The video sink 190 represents various hardware and/or software components in a decoding terminal that may consume the reconstructed video. The video sink 190 typically may include one or more display devices on which reconstructed video may be rendered. Alternatively, the video sink 190 may be represented by a memory system that stores the reconstructed video for later use. The video sink 190 also may include one or more application programs that process the reconstructed video data according to controls provided in the application program. In some embodiments, the video sink may represent a transmission system that transmits the reconstructed video to a display on another device, separate from the decoding terminal. For example, reconstructed video generated by a notebook computer may be transmitted to a large flat panel display for viewing.

The foregoing discussion of the encoding terminal and the decoding terminal (FIGS. 1(b) and 1(c)) illustrates operations that are performed to code and decode video data in a single direction between terminals, such as from terminal 110 to terminal 150 (FIG. 1(a)). In applications where bidirectional exchange of video is to be performed between the terminals 110, 150, each terminal 110, 150 will possess the functional units associated with an encoding terminal (FIG. 1(b)) and each terminal 110, 150 also will possess the functional units associated with a decoding terminal (FIG. 1(c)). Indeed, in certain applications, terminals 110, 150 may exchange multiple streams of coded video in a single direction, in which case, a single terminal (say terminal 110) will have multiple instances of an encoding terminal (FIG. 1(b)) provided therein. Such implementations, although not illustrated in FIG. 1, are fully consistent with the present discussion.

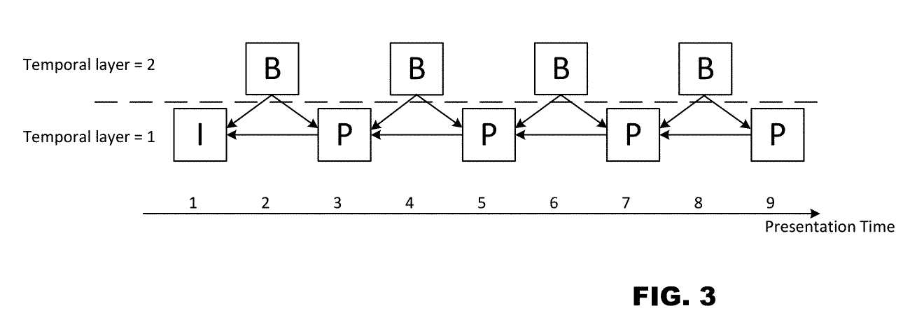

Video coding techniques H.264 and H.265 introduced flexible coding structures (such as hierarchical, dyadic structures). FIGS. 3-5 show popular hierarchical coding structures with different number of temporal layers. Each temporal layer provides frame rate scalability in that each temporal layer can be decoded without reference to any higher temporal layers. This allows for a sub-bitstream extraction process sequentially starting from a top layer without affecting the decoding ability of temporal layer pictures lower than the extracted temporal layers.

This section details a subset of signaling mechanism defined in HEVC standard to signal temporal layers.

A subset of the HEVC standard specifies a mechanism for signaling temporal layers. HEVC temporal layer signaling includes TemporalID, vps_max_sub_layers_minus1, sps_max_sub_layers_minus1. TemporalID is signaled in the network abstraction layer (NAL) unit header to specify the temporal identifier of that temporal layer and a sub-bitstream extraction process could use temporalID to extract the sub-bitstream corresponding to target frame rate. vps_max_sub_layers_minus1 or sps_max_sub_layers_minus1 specifies the maximum number of temporal sub-layers that may be present in each coded video sequence (CVS) referring to the video parameter set (VPS) syntax element and sequence parameter set (SPS) syntax element respectively.

A reference picture set specifies the prediction referencing of pictures. A reference picture set is a set of reference pictures associated with a current picture to be encoded or decoded, where the reference picture set may consist of all reference pictures that are prior to the current picture in coding order (the order frame are encoded or decoded, and is different from presentation order) that may be used for inter-prediction of the picture to be decoded or any picture following the current picture in decoding order.

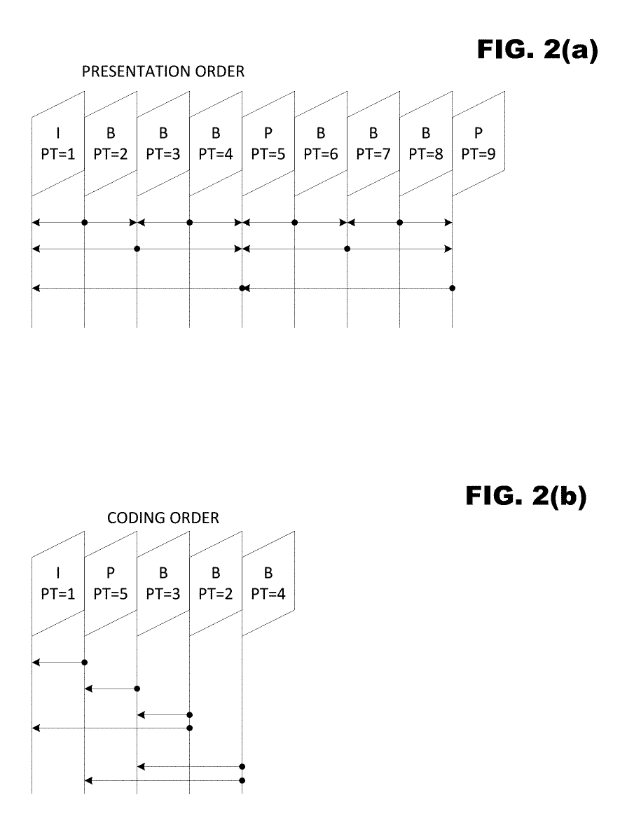

FIG. 2(a) depicts an example video sequence in presentation order with a dyadic prediction structure. Presentation time increases from left to right, with each frame labeled with a presentation time “PT.” The first frame on the left is the PT=1 frame which is encoded as an I-frame, and hence does not predicted from any other frames. The reference picture set for the PT=1 frame is empty. The second frame in presentation time, PT=2, is a B-frame, which may be predicted from two other frames. The arrows under the frames in FIG. 2(a) indicate which reference frames are used to predict any frame. For frame PT=2, the two arrows originating at a dot from frame PT=2 indicate frame PT=2 is may be predicted using only frame PT=1 and PT=3, and hence the reference picture set for PT=2 includes the set PT=1 and PT=3. For frame PT=3, the arrows indicate a reference frame of PT=1 and PT=5. For PT=5, which is encoded as a P-picture, the reference frame set includes only PT=1.

FIG. 2(b) depicts an example video sequence in coding order with a dyadic prediction structure. Coding order is the order of frames in which an encoder may encodes or a decoder may decode. In FIG. 2(b), the frames PT=1 to PT=5 from FIG. 2(a) are reordered into the coding order. As the prediction arrows indicate, every frame in coding order only predicts from reference frames for which are earlier in coder order. This can be seen in FIG. 2(b) because all prediction arrows point only to the left, to frames earlier in the coding order.

Temporal layering may impose further constraints on prediction referencing. HEVC includes such constraints and signaling schemes to achieve smooth playback, efficient trick play, and fast forward/rewind functionality with temporal layering. In the HEVC temporal layering, pictures with lower temporal layer cannot predict from pictures with higher temporal layer. The temporal layer is signaled in the bitstream and interpreted to be TemporalID. Other restrictions include the signaling of STSA and TSA pictures that disallow within sub-layer prediction referencing at various points in the bitstream to indicate the capability of up-switching to different frame rates.

FIG. 3 depicts an example video sequence with two temporal layers in a dyadic prediction structure. The hierarchical prediction structure in FIG. 3 has two temporal layers and a group-of-pictures (GOP) size of 2. Decoding the temporal layer 1 provides half the target frame-rate and decoding up to temporal layer 2 provides the target frame rate. The lowest temporal layer, layer 1, includes frames 1, 3, 5, 7, and 9 (numbered in presentation order). Prediction references are indicated with arrows, were arrows point to prediction reference frames from the frames that are predicted. Hence, frame 3 (a P-frame) is predicted from only frame 1, and frame 1 (an I-frame) is not predicted. The lowest layer uses only prediction references that are in that lowest layer. Temporal layer 2 includes frames 2, 4, 6, and 8, which are all B-frames with two prediction references. Each frame in layer 2 predicts from frames in the layers beneath it. For example, frame 2 depends from frames 1 and 3.

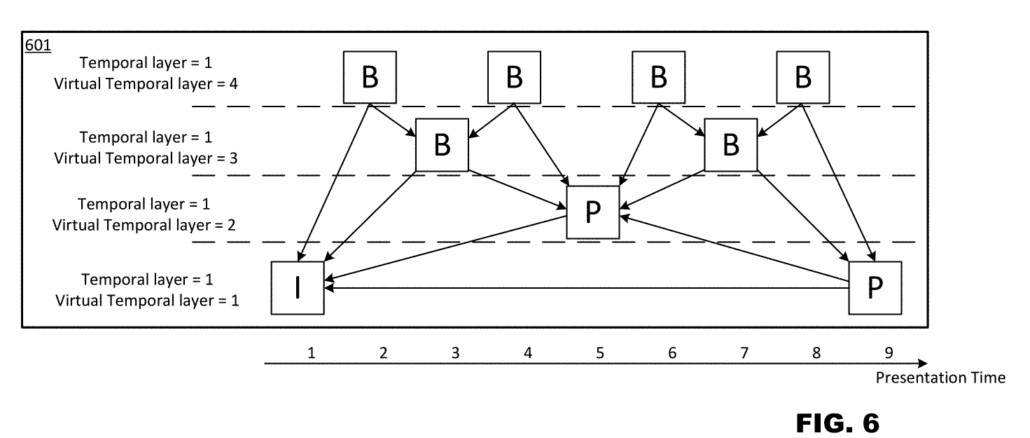

A hierarchical dyadic structure is a constraint on layered prediction scheme whereby every B-frame may only be predicted by immediately neighboring frames (in presentation order) from the current temporal layer or a lower temporal layer. In a hierarchical dyadic structure, the GOP size n is an integer power of 2, and if m is the number of B-pictures between consecutive non-B frames, the GOP contains one leading I-picture and (n/m+1)−1 P-frames and every P-frame is predicted from immediately previous P-frame's or I-frame's. A hierarchical dyadic structure allows exactly half of the frame rate reduction for every temporal layer extracted. In embodiments, all I-pictures and P-pictures may be encoded only as members of the bottom two virtual temporal layers, that is virtual temporal layers 1 and 2 of FIGS. 6-8.

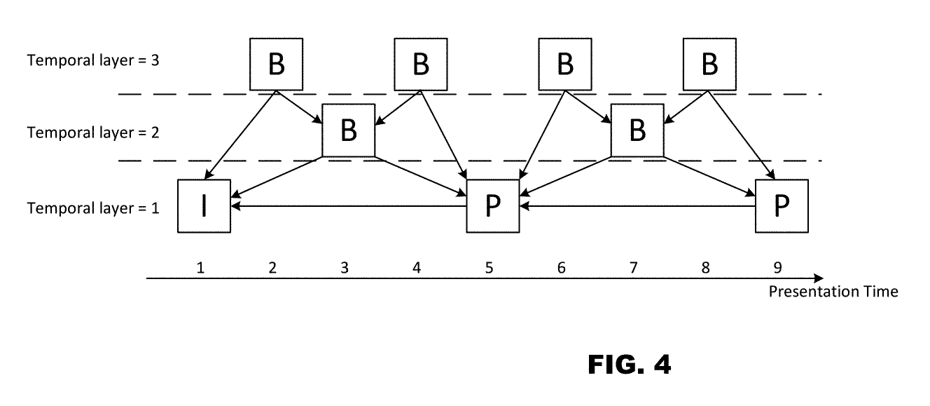

FIG. 4 depicts an example video sequence with three temporal layers in a dyadic prediction structure. The hierarchical prediction structure in FIG. 4 has three temporal layers and a GOP size of 4. The prediction structure of FIG. 4 matches the prediction structure of FIG. 2(a) with added temporal layering. Decoding the temporal layer 1 provides one-fourth of the target frame-rate, and decoding temporal layers 1 and 2 provides the half of the target frame rate, and so on.

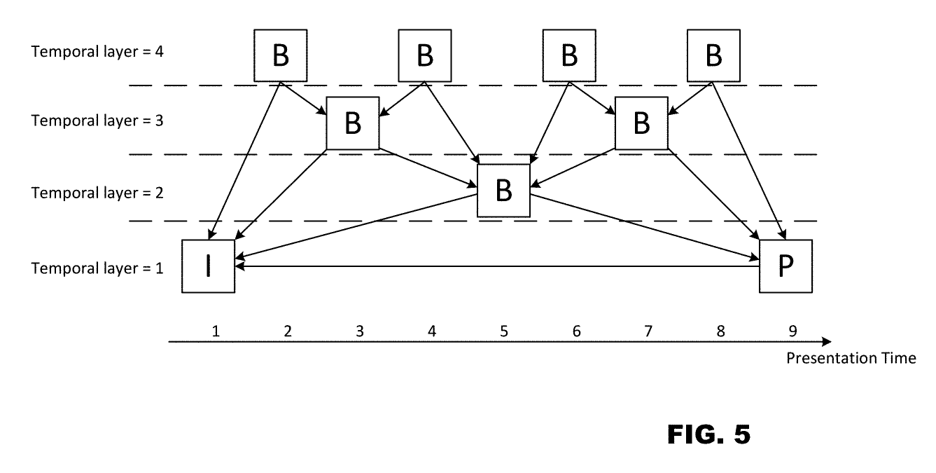

FIG. 5 depicts a video sequence with four temporal layers in a dyadic prediction structure. The hierarchical prediction structure in FIG. 5 has four temporal layers and a GOP size of 8. Decoding the temporal layer 1 provides one-eighth of the target frame-rate, decoding temporal layers 1 and 2 provides the one-fourth of the target frame rate, and so on.

Coding efficiency may be reduced when the number of possible reference pictures is reduced. Hence the visual quality of video encoded with temporal layering may be reduced due to the additional prediction constraints imposed a temporal layering system.

In a real-time video encoding system, the frame rate of images arriving at an encoder may vary from an expected target frame rate. Varying source frame rates may be caused by factors such as camera fluctuations under various lighting conditions, transcoding variable frame rate sequences, or the encoder capability. For example, encoding, even non-real-time encoding a source video signal that includes a splice from a first camera that captures at a first frame rate to a second camera that captures with a second frame rate, different from the first frame rate.

These fluctuations may result in the encoder receiving frames at irregular intervals in time, potentially causing missing frames at the expected point in time, given a target frame rate. A encoding system with a fixed or constant number of virtual temporal layers in a varying frame rate environment may provide a prediction structure that balances trade-offs among video quality, complexity (storage), latency and ease of encoder implementation across a wide variation in instantaneous frame rates.

Various design challenges may occur when designing a prediction structure. For example, a first design challenge is selection of an optimal number of temporal layers. Traditionally, the number of temporal layers are chosen based on the desired frame rates. For example, in the scenario where the target frame rate is same as base layer frame rate a prediction structure as in FIG. 1 may be used. A second design challenge is selection of an optimal GOP size. The bigger GOP sizes increase the memory requirement and latency, while providing more prediction referencing flexibility. A third design challenge is seamless handling of real-time frame rate fluctuations, and variable frame rate encoding. Frequently switching to a different prediction structures based on instantaneous frame rate and a base layer frame rate would require different on-the-fly handlings for missing frames, frame rate fluctuations in each of the prediction structure etc. This may not only lead to implementation burden but also non-smooth playback quality.

The following embodiments may be applied separately or jointly in combination to address various challenges in designing prediction structure for video encoding with temporal layering. These embodiments include a generalized structure of motion prediction that provide a good trade-off when operating at arbitrary set of target frame rate and arbitrary base layer frame rate.

The number of signaled temporal layers and the TemporalID for a particular picture are signaled in the bitstream based on a target frame rate (the highest frame rate a decoder can decode, by decoding all layers) and a required base layer frame rate (a minimum frame rate a decoder is expected to decode, by decoding only the base layer):

num_temporal_layers=Max(log 2(target frame rate/base layer frame rate)+1), N)

where num_temporal_layers is the number of temporal layers signaled in a bitstream, and N is a chosen number for the total number of virtual temporal layers. In one example implementation, N is set to 4 and would result in the dyadic prediction structures illustrated in FIGS. 6-8. In other examples, N could take values from 3 to 7. A higher number of virtual temporal layers may result in greater compression by increasing the amount of motion prediction. The number of virtual temporal layers may be selected as the desired number of layers in a dyadic prediction structure. Increasing the base layer frame rate will increase the presented frame rate from video decoders that will decode only the lowest temporal layer of videos encoded with more than one temporal layer.

The total number of virtual temporal layers, N, may be chosen, for example, by balancing compression quality (compression ratio or image quality at a bitrate), latency, and complexity (of an encoder or decoder). A higher N will generally lead to high compression quality, but will also lead to longer latency and more complexity. A lower N will generally produce lower compression quality, but will gain reduced latency and reduced complexity.

If the target frame rate for a set of pictures is higher than the base layer frame rate, those set of pictures may be signaled in the encoded bitstream as enhancement temporal layer pictures (TemporalID>1). Note that TemporalID in this convention starts from 1 and base layer pictures have TemporalID=1. The rest of the pictures that are not signaled as non-enhancement temporal layer pictures (treated as base layer pictures) may be further split into “virtual temporal layers” based on their temporal referencing. These virtual temporal layers are together signaled in an encoded bitstream as a single base layer (TemporalID=1).

The term “virtual temporal layers” specifies the further non-signaled temporal layering structure within a single signaled temporal layer, such as a single HEVC temporal layer. In some embodiments, only the base temporal layer (TemporalID=1) may contain a plurality of virtual temporal layers.

In one embodiment, the total number of virtual layers is chosen independent of target frame rate and required base layer frame rate. In this embodiment, the number of virtual temporal layers is fixed to N for different target frame rates and base layer frame rates. In one example, N is set to 4.

In other embodiments, the number of virtual temporal layers within a signaled temporal layer (for example an HEVC temporal sub-layer) is chosen based on target frame rate and base layer frame rate. In one example, when target frame rate is equal to base layer frame rate, the number of virtual temporal layers for temporalID=1 layer is chosen to be 4 and when target frame rate is equal to 2*base layer frame rate, the number of virtual temporal layers for temporalID=1 is chosen to be 3.

In another other example, the number of virtual temporal layers for the TemporalID=1 signaled layer is:

N−Max(log 2(target frame rate/base layer frame rate)+1), N)

In one example implementation, N is set to 4 and would result in prediction structures illustrated in FIGS. 6-8. In other examples, N could take values from 3 to 7.

Varying the number of virtual temporal layers trades off complexity vs video quality. More virtual temporal layers lead to more complexity and higher video quality at an encoded bitrate. Here the complexity may include amount of storage for decoded picture buffers, latency at the playback etc. The temporal layers trade-off frame rate modulation flexibility vs video quality.

The examples of FIGS. 6-8 depict use of virtual temporal layers to create a dyadic prediction structures for a varying number of signaled temporal layers and varying base layer frame rate. FIG. 6 depicts an example a video sequence with four virtual temporal layers in a dyadic prediction structure and one signaled temporal layer. Box 601 indicates the pictures included in the base-layer, and implies the base layer frame rate. In the example of FIG. 6, the target frame rate equals the base laser layer frame rate, the number of signaled temporal layers=1 and number of virtual temporal layers=4. In FIG. 6, the base layer includes 4 virtual sub-layers.

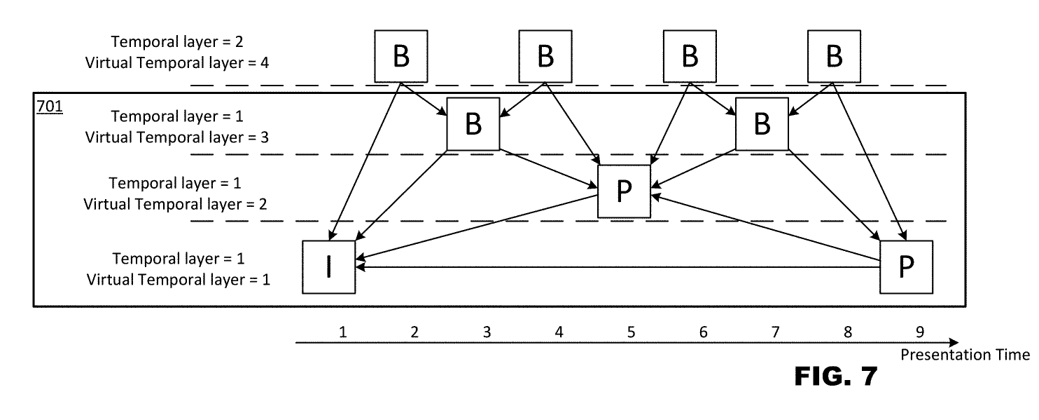

FIG. 7 depicts an example a video sequence with four virtual temporal layers in a dyadic prediction structure and two signaled temporal layers. Box 701 indicates the pictures included in the base-layer, and implies the base layer frame rate. In the example of FIG. 7, the target frame rate equals twice the base laser layer frame rate, the number of signaled temporal layers=2 and number of virtual temporal layers=4. In FIG. 7, the base layer includes 3 virtual sub-layers.

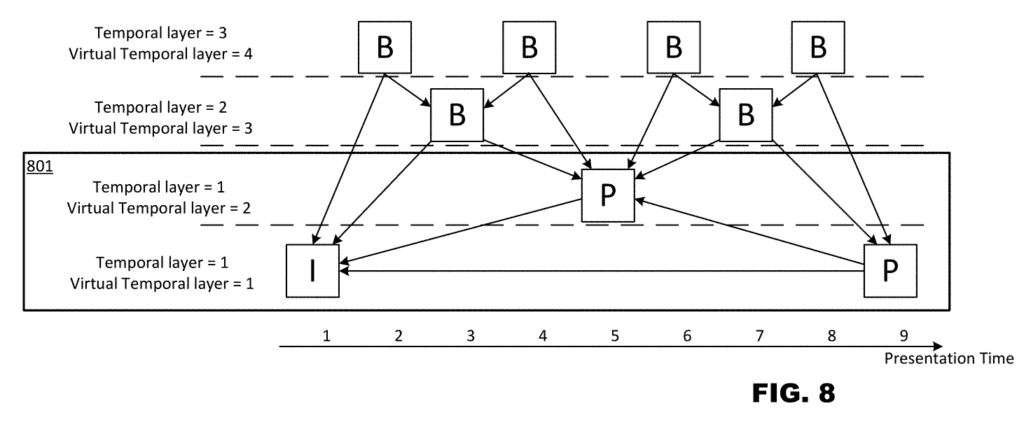

FIG. 8 depicts an example a video sequence with four virtual temporal layers in a dyadic prediction structure and three signaled temporal layers. Box 801 indicates the pictures included in the base-layer, and implies the base layer frame rate. In the example of FIG. 7, the target frame rate is four times the base laser layer frame rate, the number of signaled temporal layers=3 and number of virtual temporal layers=4. In FIG. 7, the base layer includes 2 virtual sub-layers.

Benefits of using virtual temporal layers, as in FIGS. 6-8, over traditional methods include higher coding efficiency and smooth image quality transitions in varying source frame rate conditions (or missing source frames). The generalized structure provides higher coding efficiency as it can incorporate a reference B frames (such as in FIG. 6 virtual temporal layers 3 and 4) even when target frame rate and base layer frame rate are same (say in comparison to FIG. 3). The structure of FIG. 3, results in only up to 50% of all frames are B-frames, where as the example of FIG. 6 results in up to 75% of all frames being B-frames, thereby providing higher coding efficiency. In addition, the pictures in signaled TemporalID=1 (which may have multiple virtual temporal layers) can predict from any virtual temporal sub-layers in that signaled layer, even virtual temporal layers higher than the current picture that are within the that signaled layer.

Other benefits of prediction structure of FIGS. 6-8 are that the prediction structure may be adapted in real-time as the frame rate input to an encoder changes (or an expected input frame is missing), while maintaining the same base layer frame rate in the output from the encoder despite the varying input frame rate. Varying source frame rates can be addressed with the prediction structure of FIGS. 6-8 by handling missing frames using one of the following method.

First, when a picture with virtual temporal layer>2 is missing, references for other B-frames that are present that have virtual temporal layer>2 are modified to predict from pictures that are in a virtual temporal layer lower than the temporal layer of the missing frame. For example, when a picture from virtual layer=3 is missing, then any pictures that would have used the missing picture as a reference picture will instead use the nearest neighboring frame in a virtual temporal layer less than 3 (i.e. from either virtual temporal layer 1 or 2). For example, in any of the FIGS. 6-8, frame 4 is predicted from frames 3 and 5, but if frame 3 is missing, frame 4 may be predicted instead from frames 1 and 5. Frame 3 is the left-side neighbor of frame 4. If frame 3 is missing, frame 1 is chosen to replace frame 3 as the left-side prediction reference because frame 1 is nearest left-side neighbor to frame 4 that is also in virtual temporal layers 1 or 2. In another example, if the frame 4 is lost, then no change to referencing for other pictures needs to be done as frame 4 is not used as a prediction reference for any remaining pictures.

Second, when a picture with virtual temporal layer<=2 is missing, the next available picture immediately after the missing picture is promoted to virtual temporal layer=1 or 2 based on the number of missing pictures. For example, in FIG. 8, if frame 5 is missing, frame 6 is promoted by encoding it as signaled temporal layer 1 (virtual temporal layer 2) instead of signaled temporal layer 3 (virtual temporal layer 4) as depicted in the FIG. 8. In this case of missing frame 5, frame 7 will be predicted from frames 6 and 9 instead of frames 5 and 9, and frame 8 will be predicted from frames 7 and 9. It may be observed that the referencing scheme for FIGS. 6-8 is same for different missing frames and FIGS. 6-8 realize different frame rate modulation from target bitrate to target bitrate. In contrast, without the use of virtual temporal layers, for example in the dyadic structures employed in FIGS. 3-5, it may be observed that the referencing schemes must completely change when a frame is missing frames for any of FIGS. 3-5, which leads to excessive implementation complexity as compared to virtual temporal layering schemes.

The temporalID for the pictures are assigned according to the picture timing of the incoming pictures.

A benefit of handling missing frames according to these methods is that they are implementation-friendly. These method reduce encoder complexity for addressing missing frames. When the number of virtual temporal layers are same, the handling of missing pictures works in the same way independent of the target frame rate and the base layer frame rate.

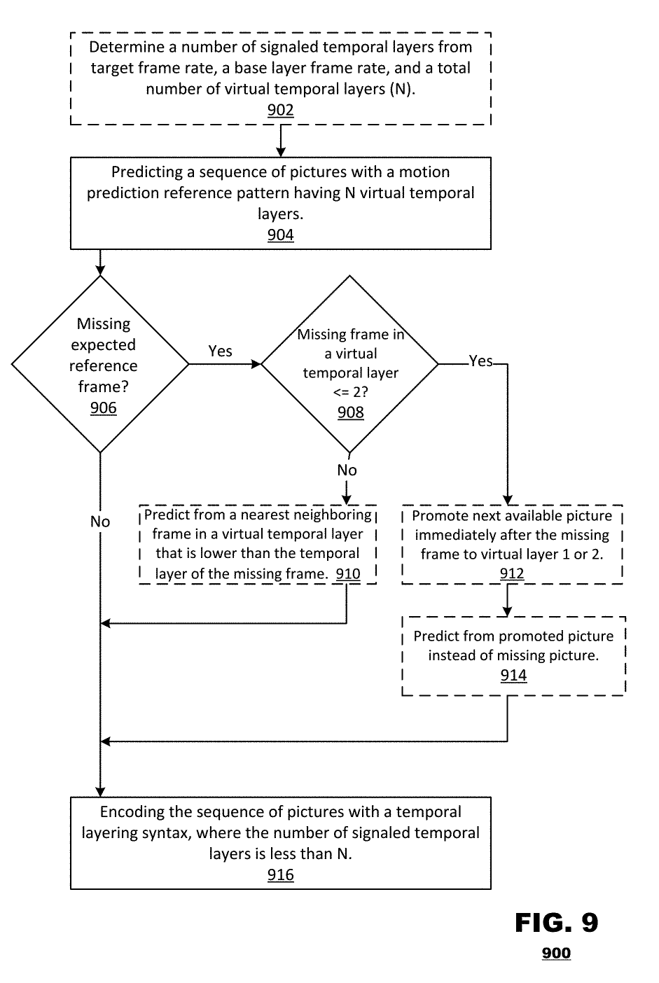

FIG. 9 depicts a flowchart of an example process for encoding a video with virtual temporal layers. In optional box 902, a the number of signaled temporal layers to be encoded in a compressed bitstream is determined from :1) a target frame rate (this the highest frame rate, and the frame rate resulting from decoding all signaled temporal layers); 2) a base layer frame rate (this is the frame rate of the signaled base layer and the lowest frame rate a decoder can select to decode); and 3) a total number virtual temporal layers, N. In box 904, a sequence of pictures is predicted using a prediction reference pattern having N virtual temporal layers. Then, in box 916, the sequence of pictures is encoded with a temporal layering syntax, where the number of signaled temporal layers is less than N.

In some embodiment, an encoder may adapt a prediction pattern when expected reference pictures are missing at the input to an encoder. In these embodiments, optional boxes 906, 908, 910, 912, and 914 may adapt the prediction pattern. In box 906, determines if an expected reference frame is missing, for example in a real-time encoder. If no reference frame is missing encoding continues as normal in box 916. When a reference frame is missing, in box 908, if the virtual temporal layer that would have been assigned is to the missing frame is less than or equal to 2, control flow moves to box 912, otherwise control flow moves to box 910. In box 910, where the missing frames virtual temporal layer was >2, frames that would have been predicted using the missing frame as a prediction reference instead predict from the nearest neighboring (not missing) frame that is in a virtual temporal layer lower than the virtual temporal layer of the missing frame. In box 912, where the missing frame's virtual temporal layer is <=2, the next available picture immediately following the missing frame is promoted to virtual layer 1 or 2 (that is, the next available picture is encoded in virtual layer 1 or 2). After promotion, in box 914, any picture that would have been predicted from the missing frame will instead use the promoted picture as a reference frame.

As discussed above, FIGS. 1(a), 1(b), and 1(c) illustrate functional block diagrams of terminals. In implementation, the terminals may be embodied as hardware systems, in which case, the illustrated blocks may correspond to circuit sub-systems. Alternatively, the terminals may be embodied as software systems, in which case, the blocks illustrated may correspond to program modules within software programs executed by a computer processor. In yet another embodiment, the terminals may be hybrid systems involving both hardware circuit systems and software programs. Moreover, not all of the functional blocks described herein need be provided or need be provided as separate units. For example, although FIG. 1(b) illustrates the components of an exemplary encoder, including components such as the pre-processor 135 and coding system 140, as separate units. In one or more embodiments, some components may be integrated. Such implementation details are immaterial to the operation of the present invention unless otherwise noted above. Similarly, the encoding, decoding and post-processing operations described with relation to FIG. 9 may be performed continuously as data is input into the encoder/decoder decoder. The order of the steps as described above does not limit the order of operations.

Some embodiments may be implemented, for example, using a non-transitory computer-readable storage medium or article which may store an instruction or a set of instructions that, if executed by a processor, may cause the processor to perform a method in accordance with the disclosed embodiments. The exemplary methods and computer program instructions may be embodied on a non-transitory machine readable storage medium. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device.

While the invention has been described in detail above with reference to some embodiments, variations within the scope and spirit of the invention will be apparent to those of ordinary skill in the art. Thus, the invention should be considered as limited only by the scope of the appended claims.

1. A method for encoding video, comprising:
predicting a sequence of pictures with a motion prediction reference pattern having a number of virtual temporal layers N; and
encoding the sequence of pictures into an encoded bitstream with a temporal layering syntax, wherein a number of signaled temporal layers is less than N.

2. The method of claim 1, further comprising:
determining the number of virtual temporal layers within a signaled temporal layer from a target highest frame rate, a target base layer frame rate, and N.

3. The method of claim 2, wherein the number of virtual temporal layers within a signaled base temporal layer is determined as the max (N, (log 2(the target highest frame rate/the target base layer frame rate)+1)).

4. The method of claim 1, further comprising:
when a reference frame in a virtual temporal layer>2 is missing, using a nearest neighboring frame in virtual temporal layers 1 or 2 as a reference frame instead.

5. The method of claim 1, further comprising:
when a reference frame in a virtual temporal layer<=2 is missing, encoding the next available picture immediately after the missing picture in either layer 1 or 2, depending on how many frame are missing.

6. The method of claim 1, further comprising:
in response to a missing frame expected at the input to an encoder, not changing the number of virtual temporal layers used to determine the prediction reference structure for subsequently received frames.

7. The encoded bitstream product of a process comprising:
predicting a sequence of pictures with a motion prediction reference pattern having a number of virtual temporal layers N; and
encoding the sequence of pictures into an encoded bitstream with a temporal layering syntax, wherein a number of signaled temporal layers is less than N.

8. A non-transitory computer readable memory comprising instructions, that when executed on a computer processor, cause:
predicting a sequence of pictures with a motion prediction reference pattern having a number of virtual temporal layers N; and
encoding the sequence of pictures into an encoded bitstream with a temporal layering syntax, wherein a number of signaled temporal layers is less than N.

9. The computer readable memory of claim 8, wherein the instructions further cause:
determining the number of virtual temporal layers within a signaled temporal layer from a target highest frame rate, a target base layer frame rate, and N.

10. The computer readable memory of claim 9, wherein the number of virtual temporal layers within a signaled base temporal layer is determined as the max (N, (log 2(the target highest frame rate/the target base layer frame rate)+1)).

11. The computer readable memory of claim 8, further comprising:
when a reference frame in a virtual temporal layer>2 is missing, using a nearest neighboring frame in virtual temporal layers 1 or 2 as a reference frame instead.

12. The computer readable memory of claim 8:
when a reference frame in a virtual temporal layer<=2 is missing, encoding the next available picture immediately after the missing picture in either layer 1 or 2, depending on how many frame are missing.

13. The computer readable memory of claim 8, further comprising:
in response to a missing frame expected at the input to an encoder, not changing the number of virtual temporal layers used to determine the prediction reference structure for subsequently received frames.

14. A video coding system, comprising:
a predictor of pixel blocks configured to predict a sequence of pictures with a motion prediction reference pattern having a number of virtual temporal layers N; and
an encoder of pixel blocks configured to encode the sequence of pictures into an encoded bitstream with a temporal layering syntax, wherein a number of signaled temporal layers is less than N.

15. The system of claim 14, wherein the predictor is further configured to:
determine the number of virtual temporal layers within a signaled temporal layer from a target highest frame rate, a target base layer frame rate, and N.

16. The system of claim 15, wherein the number of virtual temporal layers within a signaled base temporal layer is determined as the max (N, (log 2(the target highest frame rate/the target base layer frame rate)+1)).

17. The system of claim 14, wherein the predictor is further configured to:
when a reference frame in a virtual temporal layer>2 is missing, using a nearest neighboring frame in virtual temporal layers 1 or 2 as a reference frame instead.

18. The system of claim 14, wherein the predictor is further configured to:
when a reference frame in a virtual temporal layer<=2 is missing, encoding the next available picture immediately after the missing picture in either layer 1 or 2, depending on how many frame are missing.

19. The system of claim 14, wherein the predictor is further configured to:
in response to a missing frame expected at the input to the encoding system, not changing the number of virtual temporal layers used to determine the prediction reference structure for subsequently received frames.
